(19) United States
(12) Patent Application Publication
(10) Pub. No.: US 2025/0337484 A1
(43) Pub. Date: Oct. 30, 2025

(54) DYNAMIC SATELLITE BASE STATION SPECTRUM ALLOCATION

(71) Applicant: T-MOBILE INNOVATIONS LLC, Overland Park, KS (US)

(72) Inventor: Akin OZOZLU, McLean, VA (US)

(21) Appl. No.: 18/645,733

(22) Filed: Apr. 25, 2024

(51) Int. Cl. H04B 7/185

(52) U.S. Cl. CPC H04B 7/18539; H04B 7/18521; H04B 7/18547; H04B 7/18563

(57) ABSTRACT

Embodiments of the present disclosure describe systems and methods for dynamic spectrum management and interference mitigation in mobile communications through a network of satellite base stations. Embodiments herein monitor communication traffic across a geographic area served by one or more satellite base stations. The monitoring of the traffic includes determining spectrum assignments for the terrestrial network within the geographic area. In response, the system dynamically adjusts a spectrum assignment to the one or more satellite base stations so the assigned spectrum reduces cross spectrum interference.

### SUMMARY

The present disclosure is directed to improving the mitigation of the effects of satellite base stations and terrestrial wireless base stations concurrently operating within a geographic region, substantially as shown and/or described in connection with at least one of the Figures, and as set forth more completely in the claims.

### BRIEF DESCRIPTION OF THE DRAWINGS

Aspects of the present disclosure are described in detail herein with reference to the attached Figures, which are intended to be exemplary and non-limiting, wherein:

FIG. 1 illustrates an exemplary computing device for use with the present disclosure;

FIG. 2 depicts a network environment in which implementations of the present disclosure may be employed, in accordance with aspects herein;

FIG. 3 depicts a network environment in which implementations of the present disclosure may be employed, in accordance with aspects herein;

FIG. 4 depicts a network environment in which implementations of the present disclosure may be employed, in accordance with aspects herein;

FIG. 5 depicts a flow diagram of a second method for dynamic spectrum management and interference mitigation in mobile communications in accordance with aspects herein; and

FIG. 6 depicts a flow diagram of a second method for dynamic spectrum management and interference mitigation in mobile communications in accordance with aspects herein.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms can be found in Newton's Telecom Dictionary, (e.g., 32d Edition, 2022). As used herein, the term “base station” refers to a centralized component or system of components that is configured to wirelessly communicate (receive and/or transmit signals) with a plurality of stations (i.e., wireless communication devices, also referred to herein as user equipment (UE(s))) in a particular geographic area. As used herein, the term “network access technology (NAT)” is synonymous with wireless communication protocol and is an umbrella term used to refer to the particular technological standard/protocol that governs the communication between a UE and a base station; examples of network access technologies include 3G, 4G, 5G, 6G, 802.11x, and the like. The term “node” is used to refer to network access technology for the provision of wireless telecommunication services from a base station to one or more electronic devices, such as an eNodeB, gNodeB, etc. The term “cell” is used to describe one or more hardware and software components of a base station that are configured to provide wireless communication service to a geographic area.

Computer-readable media include both volatile and nonvolatile media, removable and non-removable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions-including data structures and program modules—in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

By way of background, the advent and integration of satellite base stations in the mobile communications network mark an evolution from the traditional terrestrial-based systems. These satellite networks have been instrumental in extending connectivity to geographically isolated regions, thereby overcoming the limitations imposed by terrestrial infrastructures such as geographical barriers and regulatory constraints. Satellite base stations facilitate a broader coverage area, enabling a seamless global communication network. This technological leap has been driven by the necessity to bridge the connectivity gap in remote areas, where laying down terrestrial network infrastructures is neither feasible nor economically viable. The unique positioning of these stations allows for an uninterrupted line of sight communication, enhancing signal reliability and network performance across vast distances.

Conventionally, satellite networks have been allocated fixed bands of the spectrum that attempt to reduce overlap with terrestrial networks to avoid interference. These allocations are determined based on long-term projections and regulatory frameworks, which often cannot adapt quickly to changes in network demand or geography. This method, while providing a basic level of interference management, lacks flexibility and does not account for the dynamic nature of modern communication networks. The static approach fails to efficiently utilize available spectrum, particularly under varying conditions where terrestrial network usage might fluctuate significantly between locations. Consequently, this traditional method often results in underutilized spectral resources and can lead to congestion in densely populated areas or during peak usage times, highlighting the need for more adaptive spectrum management strategies.

Addressing the conventional challenges, the disclosed method enables satellite base stations to optimize dynamic spectrum management and interference mitigation in mobile communications. By focusing on real-time monitoring and adjusting of satellite physical resource block (PRB) allocations via satellite base stations, this technique effectively manages spectrum allocation mitigating interference between terrestrial and satellite networks. The satellite base stations actively determine patterns of terrestrial PRB allocations for geographic regions covered by the satellite base stations. By monitoring the terrestrial PRB allocations, the satellite base stations are able to determine and assign optimal satellite PRB allocations that will reduce potential interference between the terrestrial and satellite networks.

Accordingly, a first aspect of the present disclosure provides a system for providing downlink coverage to a geographical area via one or more satellite base stations caused by one or more satellite base stations providing coverage over a geographic area having one or more terrestrial base stations. The system comprises one or more computer processing components configured to perform operations. The operations comprises providing downlink coverage to a geographical area via one or more satellite base stations. The operations next monitor a terrestrial PRB allocation for the geographical area via the one or more satellite base stations. Next, the operations determine that the terrestrial PRB allocation for the geographical area is being allocated from a first end of an available spectrum. Next, the operations assign, to the one or more satellite base stations, a satellite PRB allocation from a second end of the available spectrum.

A second aspect of the present disclosure provides a method for interference mitigation in mobile communications caused by one or more satellite base stations providing coverage over a geographic area having one or more terrestrial base stations. The method comprises providing downlink coverage to a first geographical area via a plurality of satellite base stations. The method further comprises determining that the terrestrial PRB allocation for the first geographical area is being allocated in a random pattern. Additionally the method comprises monitoring, in near real-time, an interference pattern for the terrestrial PRB allocation. The method finally comprises assigning, to the one or more satellite base stations, a satellite PRB allocation from a plurality of PRBs based on a determination that the satellite PRB allocation is experiencing a lower interference pattern.

Another aspect of the present disclosure is directed to a non-transitory computer readable media having instructions stored thereon that, when executed by one or more computer processing components, cause the one or more computer processing components to perform a method for mitigating interference caused by one or more satellite base stations providing coverage over a geographic area having one or more terrestrial base stations. The method comprises providing downlink coverage to a geographical area via one or more satellite base stations. The method further comprises receiving, from a satellite constellation network, an indication that a terrestrial PRB allocation for the geographical area is being allocated from a first end of an available spectrum. The method finally comprises assigning, to the one or more satellite base stations, a satellite PRB allocation from a second end of the available spectrum.

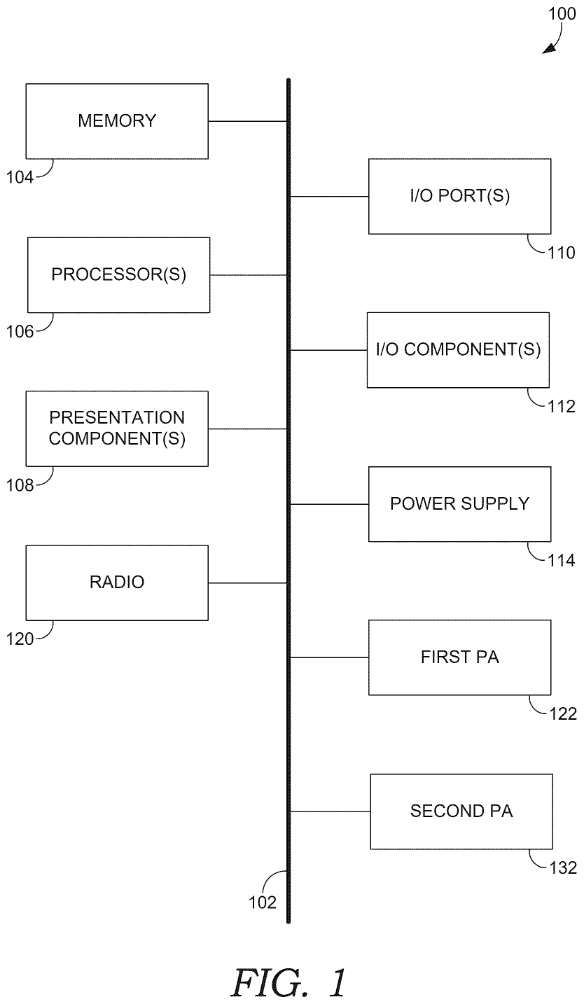

Referring to FIG. 1, an exemplary computer environment is shown and designated generally as computing device 100 that is suitable for use in implementations of the present disclosure. Computing device 100 is but one example of a suitable computing environment and is not intended to suggest any limitation as to the scope of use or functionality of the invention. Neither should computing device 100 be interpreted as having any dependency or requirement relating to any one or combination of components illustrated. In aspects, the computing device 100 is generally defined by its capability to transmit one or more signals to an access point and receive one or more signals from the access point (or some other access point); the computing device 100 may be referred to herein as a user equipment, wireless communication device, or user device, The computing device 100 may take many forms; non-limiting examples of the computing device 100 include a fixed wireless access device, cell phone, tablet, internet of things (IoT) device, smart appliance, automotive or aircraft component, pager, personal electronic device, wearable electronic device, activity tracker, desktop computer, laptop, PC, and the like.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 1, computing device 100 includes bus 102 that directly or indirectly couples the following devices: memory 104, one or more processors 106, one or more presentation components 108, input/output (I/O) ports 110, I/O components 112, and power supply 114. Bus 102 represents what may be one or more busses (such as an address bus, data bus, or combination thereof). Although the devices of FIG. 1 are shown with lines for the sake of clarity, in reality, delineating various components is not so clear, and metaphorically, the lines would more accurately be grey and fuzzy. For example, one may consider a presentation component such as a display device to be one of I/O components 112. In addition, processors, such as one or more processors 106, have memory. The present disclosure hereof recognizes that such is the nature of the art, and reiterates that FIG. 1 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of FIG. 1 and refer to “computer” or “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 104 includes computer-storage media in the form of volatile and/or nonvolatile memory. Memory 104 may be removable, non-removable, or a combination thereof. Exemplary memory includes solid-state memory, hard drives, optical-disc drives, etc. Computing device 100 includes one or more processors 106 that read data from various entities such as bus 102, memory 104 or I/O components 112. One or more presentation components 108 presents data indications to a person or other device. Exemplary one or more presentation components 108 include a display device, speaker, printing component, vibrating component, etc. I/O ports 110 allow computing device 100 to be logically coupled to other devices including I/O components 112, some of which may be built in computing device 100. Illustrative I/O components 112 include a microphone, joystick, game pad, satellite dish, scanner, printer, wireless device, etc.

A first radio 120 and second radio 140 represent radios that facilitate communication with one or more wireless networks using one or more wireless links. In aspects, the first radio 120 utilizes a first transmitter 122 to communicate with a wireless network on a first wireless link and the second radio 140 utilizes the second transmitter 132 to communicate on a second wireless link. Though two radios are shown, it is expressly conceived that a computing device with a single radio (i.e., the first radio 120 or the second radio 140) could facilitate communication over one or more wireless links with one or more wireless networks via both the first transmitter 122 and the second transmitter 132. Illustrative wireless telecommunications technologies include CDMA, GPRS, TDMA, GSM, and the like. One or both of the first radio 120 and the second radio 140 may carry wireless communication functions or operations using any number of desirable wireless communication protocols, including 802.11 (Wi-Fi), WiMAX, LTE, 3G, 4G, LTE, 5G, NR, VOLTE, or other VoIP communications. In aspects, the first radio 120 and the second radio 140 may be configured to communicate using the same protocol but in other aspects, they may be configured to communicate using different protocols. In some embodiments, including those that both radios or both wireless links are configured for communicating using the same protocol, the first radio 120 and the second radio 140 may be configured to communicate on distinct frequencies or frequency bands (e.g., as part of a carrier aggregation scheme). As can be appreciated, in various embodiments, each of the first radio 120 and the second radio 140 can be configured to support multiple technologies and/or multiple frequencies; for example, the first radio 120 may be configured to communicate with a base station according to a cellular communication protocol (e.g., 4G, 5G, 6G, or the like), and the second radio 140 may configured to communicate with one or more other computing devices according to a local area communication protocol (e.g., IEEE 802.11 series, Bluetooth, NFC, z-wave, or the like).

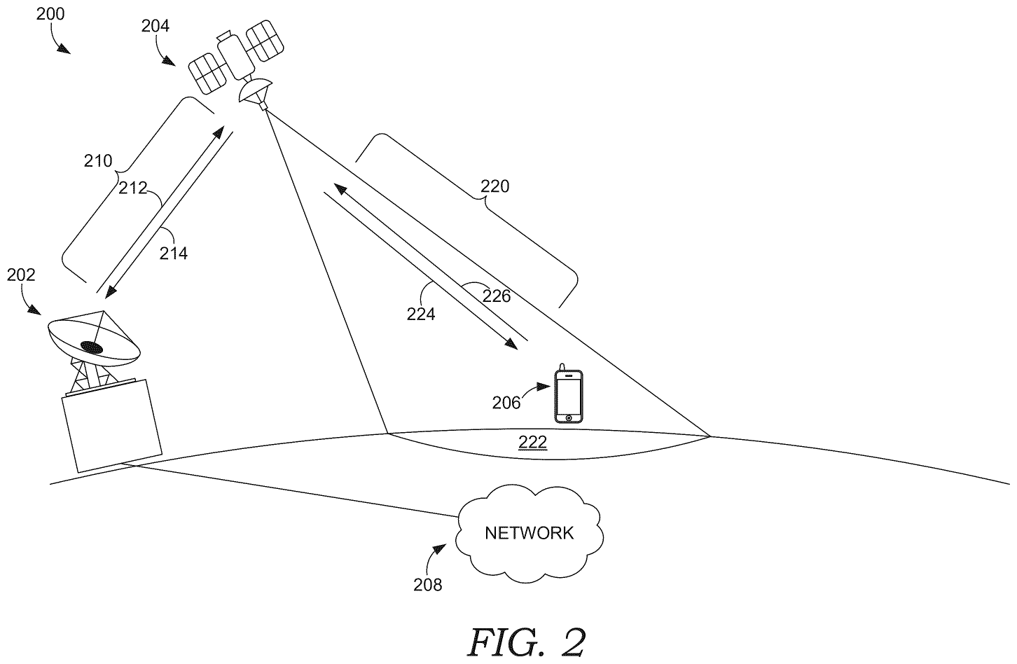

Turning now to FIG. 2, an exemplary network environment is illustrated in which implementations of the present disclosure can be employed. Such a network environment is illustrated and designated generally as network environment 200. At a high level the network environment 200 comprises a gateway 202, a satellite 204 of a satellite radio access network (RAN), a UE 206, and a network 208. Satellite 204 or any other satellite may be referred to as an extraterrestrial base station herein. In some embodiments, an extraterrestrial base station refers to a satellite such as satellite 204 or space station. Though the composition of network environment 200 illustrates objects in the singular, it should be understood that more than one of each component is expressly conceived as being within the bounds of the present disclosure; for example, the network environment 200 may comprise multiple gateways, multiple distinct networks, multiple UEs, multiple satellites that communicate with a single gateway, and the like. Similarly, though certain objects of network environment 200 are illustrated in a certain form, it should be understood that they may take other forms; for example, even though the UE 206 is illustrated as a cellular phone, a UE suitable for implementations with the present disclosure may be any computing device having any one or more aspects described with respect to FIG. 1.

The network environment 200 includes a gateway 202 communicatively connected to the network 208 and the satellite 204. The gateway 202 may be connected to the network 208 via one or more wireless or wired connections and is connected to the satellite 204 via a feeder link 210. The gateway 202 may take the form of a device or a system of components configured to communicate with the UE 206 via the satellite 204 and to provide an interface between the network 208 and the satellite 204. Generally, the gateway 202 utilizes one or more antennas to transmit signals to the satellite 204 via a forward uplink 212 and to receive signals from the satellite 204 via a return downlink 214. The gateway 202 may communicate with a plurality of satellites, including the satellite 204. The network 208 comprises any one or more public or private networks, any one or more of which may be configured as a satellite network, a publicly switched telephony network (PSTN), or a cellular telecommunications network. In aspects, the network 208 may comprise a satellite network connecting a plurality of gateways (including the gateway 202) to other networks, a cellular core network (e.g., a 4G, 5G, of 6G core network, an IMS network, and the like), and a data network. In such aspects, each of the satellite network and the cellular core network may be associated with a network identifier such as a public land mobile network (PLMN), a mobile country code, a mobile network code, or the like, wherein the network identifier associated with the satellite network is the same or different than the network identifier associated with the cellular network.

The network environment 200 includes one or more satellites, represented by satellite 204. The satellite 204 is generally configured to relay communications between the gateway 202 and the UE 206. The satellite 204 communicates with the gateway using the feeder link 210 and communicates with the UE 206 using a user link 220. The user link 220 comprises a forward downlink 224 used to communicate signals from the satellite 204 to the UE 206 and a return uplink 226 used to communicate signals from the UE 206 to the satellite 204. The satellite 204 may communicate with the UE 206 using any wireless telecommunication protocol desired by a network operator, including but not limited to 3G, 4G, 5G, 6G, 802.11x and the like. Though shown as having a single beam providing coverage to a satellite coverage area 222, the satellite 204 may be configured to utilize a plurality of individual beams to communicate with multiple different areas at or near the same time. Similarly, though a single forward downlink 224 and a single return uplink 226 are illustrated, the UE 206 may utilize multiple downlinks and/or multiple uplinks to communicate with the satellite 204, using any one or more frequencies as desired by a satellite or network operator.

Generally, the satellite 204 is characterized by its orbit around the Earth. The orbit of any particular satellite will vary by operator desire and/or intended use; for example, a satellite suitable for use with the present disclosure may be characterized by its maximum orbital altitude and/or orbital period as Low Earth Orbit (LEO), Medium Earth Orbit (MEO), and High Earth Orbit (HEO)—also referred to herein as characterizing an orbital plane. Though not rigidly defined, an LEO satellite may orbit with a maximum orbital altitude of less than approximately 1,250 miles, an MEO satellite may orbit with a maximum orbital altitude generally between 1,250 and 22,000 miles, and an HEO satellite may orbit with a maximum orbital altitude of greater than approximately 22,000 miles. In some, but not all cases, a satellite in HEO may be considered geosynchronous (i.e., geosynchronous Earth orbit (GEO)) on the basis that its orbital period is approximately equal to the length of a sidereal or solar day (approximately 24 hours); generally, a satellite in geosynchronous orbit will appear to be in the same position relative to a fixed point on the surface of the Earth at the same time each day. A geostationary orbit is a special type of geosynchronous orbit with the Earth's equator with each of an eccentricity and inclination equal to zero. Some satellites in HEO and all that are in LEO or MEO have an orbital period that is different than the length of a sidereal/solar day and are considered to be non-geosynchronous and do not remain stationary relative to a fixed position on the surface of the Earth. As used herein, a satellite in LEO has a lower orbital plane than a satellite in MEO or HEO, an MEO satellite has a higher orbital plane than a satellite in LEO, and an HEO satellite has a higher orbital plane than a satellite in LEO or MEO.

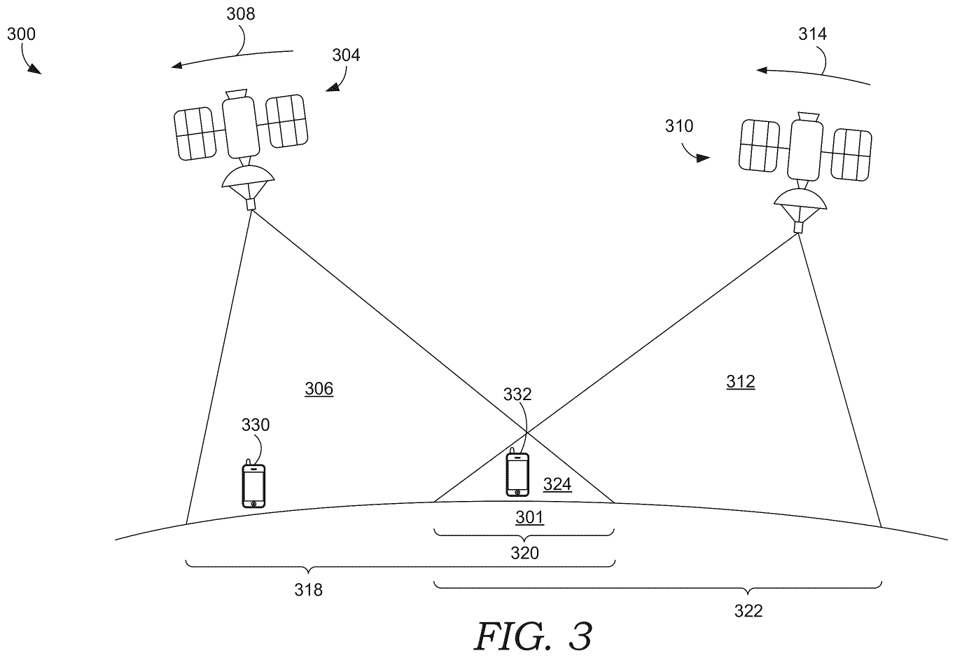

Turning now to FIG. 3, an exemplary network environment is illustrated in which implementations of the present disclosure may be employed. Such a network environment is illustrated and designated generally as network environment 300. The network environment 300 generally comprises one or more satellites, such as a first satellite 304 and a second satellite 310 and a first UE 330 at or near a surface of the Earth 301. The network environment 300 includes one or more components or functions of the network environment 200 of FIG. 2; for example, each of the first satellite 304 and the second satellite 310 of the network environment 300 have any one or more aspects of the satellite 204, and the first UE 330 of the network environment 300 have any one or more aspects of the UE 206 of network environment 200 in FIG. 2. Further, the first UE 330 and the second UE 332 are configured with one or more location services, when utilized by the first UE 330 and second UE 332, allow the first UE 330 and second UE 332 to determine their location on the Earth 301; such location services may relevantly include one or more satellite location services (e.g., global positioning system (GPS)).

In one example, the first satellite 304 has a specific orbit that determines its position relative to the Earth 301, affecting where it projects its coverage. A first coverage area 306 is the primary zone that the first satellite 304 can service. The first coverage area 306 is a three-dimensional region in space that represents the range within which devices or relay stations can communicate directly with the first satellite 304. A first Earth coverage area 318 represents the region on the surface of Earth 301 that falls within the first coverage area 306. Devices, such as the first UE 330 or communication towers within the first coverage area 306, can establish a connection with the first satellite 304. The exact shape and size of the first Earth coverage area 318 and first coverage area 306 depend on the satellite's altitude, orbit inclination, and the communication beam's management mechanism.

The second satellite 310 has its own orbit, which determines where its coverage area is projected on Earth 301. A second coverage area 312 is a primary serviceable zone for second satellite 310. Devices or relay stations within the second coverage area 312 can establish communication with the second satellite 310. Translated from the second coverage area 312, the second Earth coverage area 322 is where devices can connect with the second satellite 310. The shape and size of second coverage area 312 are influenced by various orbital and technical parameters. Given the constant movement of satellites and the vast expanse of their coverage areas, there are instances where Earth coverage areas of multiple satellites overlap. In the current example described in FIG. 3, the first Earth coverage area 318 of the first satellite 304 and the second Earth coverage area 322 of the second satellite 310 intersect, creating an overlapping coverage area 324 and an overlapping earth coverage area 320. Devices within the overlapping coverage area 324 can connect to either the first satellite 304 or the second satellite 310. Additionally, the shape and location of the coverage areas can be manipulated so the overlapping coverage area 324 is reduced in size and UEs can be serviced by a single satellite.

In the exemplary networks discussed, each network uses various slices of an available spectrum. These slices of the spectrum are allocated to the network for communications between a base station and a UE and are called a PRB. A PRB consists of a certain number of subcarriers in frequency and a specific number of symbols in time. The entire available bandwidth in a cellular network is divided into chunks allocated to different carriers or network operators. Each base station or network are allocated a particular set of PRBs from either a specific portion of the available spectrum or a random subset of the spectrum. If different base stations or networks use the same PRBs, large amounts of interference will occur causing disruption of service. Satellite communications also require the assignment of PRBs to communicate with terrestrial UEs. As such, PRBs must be assigned in a manner that allows for minimal interference.

In some embodiments, the available spectrum encompasses all the frequency ranges that are allocated for cellular network use by regulatory bodies, such as the Federal Communications Commission (FCC) in the United States or the International Telecommunication Union (ITU) globally. The available spectrum for cellular networks might range from below 600 MHZ (like the 450 MHz band in some regions) up to millimeter-wave bands that can go as high as 30 GHz or more, which are utilized particularly in newer 5G networks for their high data rate capabilities, albeit over shorter distances and with less penetration power.

Satellites, such as the first satellite 304 and the second satellite 310, provide coverage to specific geographic areas and can determine the terrestrial network's PRB allocations within their respective geographic coverage areas. Each satellite is equipped with high-sensitivity receivers that detect signals from terrestrial communication infrastructures, such as base stations and UEs, such as UE 330. These signals, encompassing both uplink and downlink communications, are analyzed to identify which frequency bands are occupied by the terrestrial network, or PRB allocations. The satellites monitor these PRB allocations to ascertain the specific frequencies being used by the terrestrial network in a specific geographic region. PRB allocations within the terrestrial network may vary, occupying the low, mid, or high end of an available spectrum, or even a random subset of the spectrum. The low end of the spectrum can include frequencies from 600 MHz to around 1-2 GHz. The high end of the spectrum can include frequencies that range from around 6 GHz to beyond 24 GHz. A mid end of the spectrum can range from 1 GHz to 6 GHz. These ranges are described herein to be exemplary and not limiting. Other ranges can be contemplated and used in various embodiments described herein.

Each satellite continuously monitors these allocations, thus identifying the spectrum usage within the terrestrial network for the geographic region they are providing coverage. This information is shared among satellites, such as first satellite 304 and second satellite 310. By sharing this terrestrial network PRB allocation information, the satellites within a constellation can determine the terrestrial PRB allocation for a geographic region they will be covering in the future and allocate PRBs accordingly. As such, it is necessary to determine satellite constellation information such as movement and coverage for each satellite within the constellation.

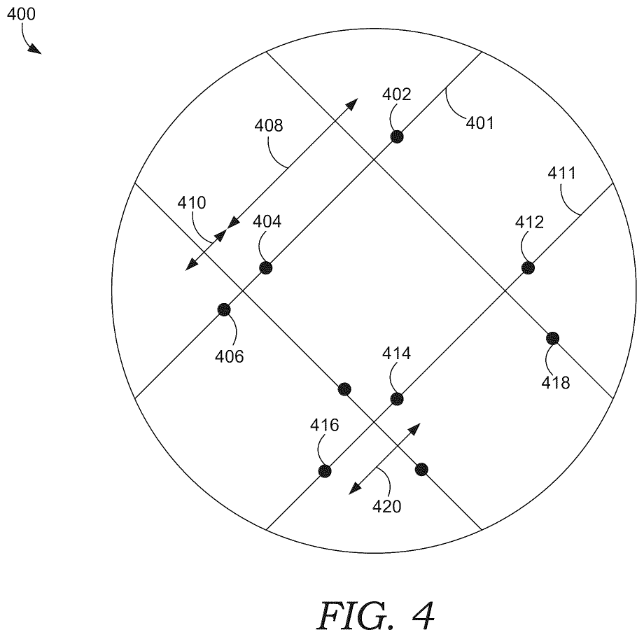

Turning now to FIG. 4, external source data comprising satellite constellation information is illustrated. The constellation information at least partially represents a satellite constellation 400. The constellation data may comprise indications that the satellite constellation includes one or more satellites; for example, the external constellation data may comprise a first satellite 402 which may represent the first satellite 304 of FIG. 3, a second satellite 404 which may represent the second satellite 310 of FIG. 3, a third satellite 406, a fourth satellite 412, a fifth satellite 414, and a sixth satellite 416. The constellation data may include indications that each of the first satellite 402, the second satellite 404, and the third satellite 406 travel along a first orbital path 401. The first satellite 402 may be separated from the second satellite 404 by a first distance 408 and the second satellite 404 may be separated from the third satellite 406 by a second distance 410, wherein the first distance 408 may be equal to or different than the second distance 410. Similarly, constellation data may comprise information that each of the fourth satellite 412, the fifth satellite 414, and the sixth satellite 416 travel along a second orbital path 411. The fourth satellite 412 may be separated from the second satellite 404 by a third distance 418 and the fifth satellite 414 may be separated from the sixth satellite 416 by a fourth distance 420, wherein the third distance 418 may be equal to or different than the fourth distance 420, the first distance 408, and the second distance 410.

Based on the external constellation data described with respect to FIG. 4, which includes the time, location, and track of one or more satellites, the first satellite 304 and/or the second satellite 310 of FIG. 3 can model, calculate, or otherwise determine their current positions and their future positions. These positions pertain to the coverage areas on the surface of the Earth for both satellites, as well as the positions of other satellites within the constellation, as depicted in FIG. 4. Further, based on the current positions of the first satellite 304 and/or the second satellite 310 of FIG. 3, and the movements of the first satellite 304 and the second satellite 310, the first satellite 304 can model, calculate, or otherwise determine a predicted future coverage area of the first satellite 304 and the second satellite 310.

Having established the mechanisms by which the first and second satellites determine their current and future positions, the system then utilizes this positional data to manage the satellite PRB allocations. The process of managing PRB allocations for each satellite within the constellation involves a coordination system that leverages the dynamic movement of each satellite within a constellation. Initially, as a satellite such as first satellite 304 moves to provide coverage over a new geographic area, it can review the terrestrial PRB allocations previously determined by any preceding satellite that covered the same area. The first satellite 304 can preview the terrestrial network PRB information by predicating its future coverage area, determining which satellite is currently covering that area, and requesting terrestrial network PRB allocation information for that coverage area. The first satellite 304 can also monitor and update the terrestrial PRB allocation frequencies based on real-time data for the geographic area it is providing coverage. The second satellite 310 can then determine that it will be providing coverage for the same geographic area as the first satellite 304, such as the first Earth coverage area 318, in the future and request the terrestrial PRB allocation data for the first Earth coverage area 318. The PRB allocation data can be exchanged between the first satellite 304 and the second satellite 310 through direct satellite-to-satellite communication or through an intermediary database system, potentially cloud-based, which serves as a central repository for PRB allocation data.

Once the second satellite 310 receives the updated terrestrial network PRB allocation frequencies for the first Earth coverage area 318, the second satellite 310 chooses to allocate PRBs at different ends of a spectrum once it begins to provide coverage for that area. For example, if it is determined that the geographical region that the second satellite 310 will provide coverage to has a terrestrial network that is using a lower end of an available spectrum, the second satellite 310 will then allocates PRBs to the second satellite 310 from an upper end of the available spectrum. Additionally, if the terrestrial network PRBs are using the upper end of the available spectrum, the second satellite 310 will choose to allocate PRBs from the lower end of the available spectrum. Further, if the terrestrial network is using PRBs from a mid-portion of the available spectrum, the second satellite 310 can choose to allocate PRBs from either the upper end or the lower end of the available spectrum.

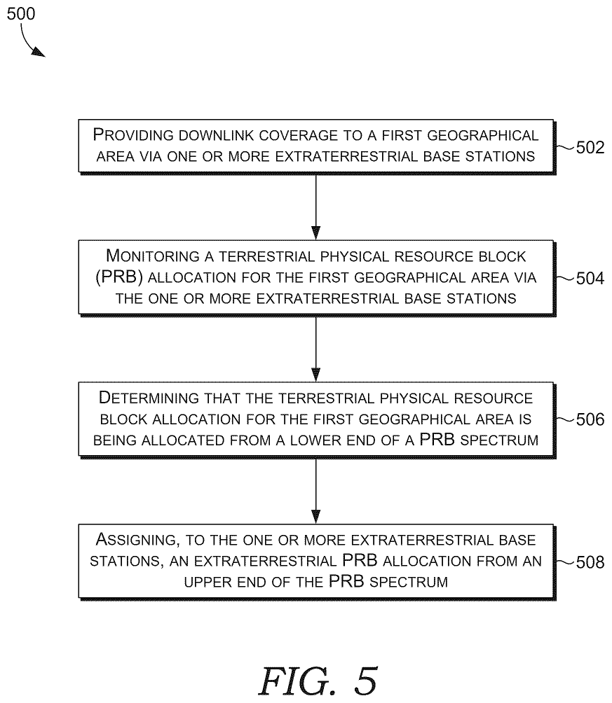

FIG. 5 illustrates a flow diagram of a method for proactively managing communication between satellite base stations and terrestrial UEs. The method 500 commences at block 502 with providing downlink coverage to a first geographical area via one or more satellite base stations. These satellite base stations are typically satellite platforms, such as the first satellite 304. The satellite uses a directed beam to cover a specific region, efficiently managing bandwidth and signal strength to maintain a consistent and reliable service. This coverage is dynamically adjusted based on the geographic and temporal demand, optimizing resource usage and improving communication quality.

Block 504 involves the monitoring of terrestrial PRB allocations for the first geographical area by the satellite base stations. This is accomplished by utilizing signal detection and analysis provided by the satellite that allow the satellite to capture and decode uplink and downlink signals from terrestrial base stations and UEs within the coverage area. By analyzing these signals, the satellite identifies the specific frequency blocks and bandwidth that are currently in use.

In block 506, it is determined that the terrestrial PRB allocation for the first geographical area predominantly comes from a first end of the bandwidth spectrum. This determination is based on the analysis of the monitored signals and involves assessing the frequency range and usage patterns of the terrestrial network. In one example, the first end of the spectrum is a low end of the spectrum. In another example, the first end of the spectrum is a high end of the spectrum.

At block 508, the method 500 provides for assigning a satellite PRB allocation to the satellite base stations from a second end of the PRB spectrum. The second end of the spectrum being opposite the first end of the spectrum. This decision is based on the existing terrestrial allocations. By utilizing different ends of the spectrum, the satellite ensures that its signals do not interfere with the terrestrial transmissions, thereby maintaining clear and distinct communication channels. This assignment is also aligned with optimizing the spectral resources, ensuring that both terrestrial and satellite layers of the network work synergistically for improved coverage and capacity.

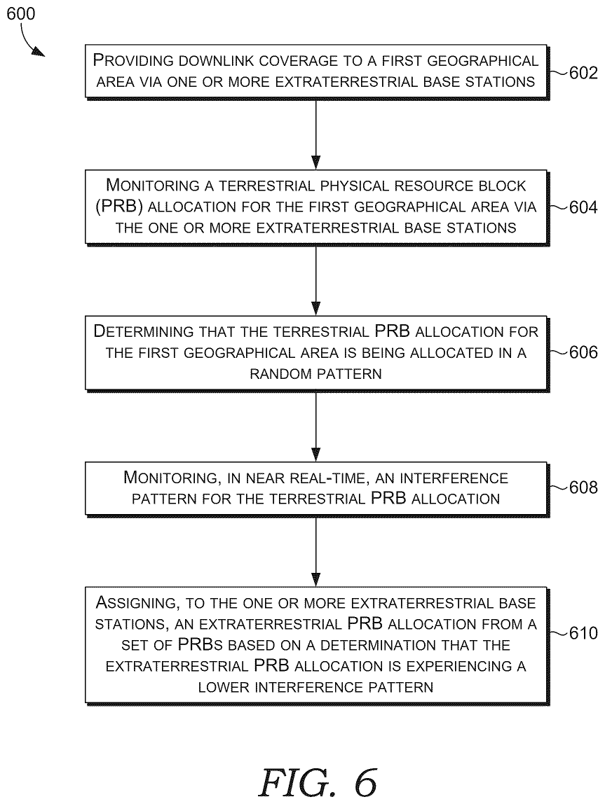

FIG. 6 illustrates a flow diagram of a method for proactively managing communication between satellite base stations and terrestrial UEs. The method 600 commences at block 602, which involves providing downlink coverage to a first geographical area through one or more satellite base stations. At block 604, the satellite base stations actively monitor the allocation of terrestrial PRBs in the first geographical area. This monitoring process involves capturing the communications between terrestrial base stations and end-user devices. This can include signal decoding and spectrum analysis to track which frequency blocks are actively being used and how resources are distributed among users.

At block 606, it is ascertained that the terrestrial PRB allocation for the geographical area follows a random pattern. This implies that the allocation does not follow a predictable or fixed pattern but rather is distributed across the available spectrum. Block 608 comprises monitoring of interference patterns associated with terrestrial PRB allocations and the PRB allocations of the satellite base station. The satellite base stations detect and analyze interference, which can affect the quality of service. This block involves the monitoring of power levels and the signal to noise ratios of transmission in the allocated PRB spectrum of the terrestrial network. By continuously scanning the allocated frequencies, the satellite can identify fluctuations in signal quality that indicate interference. The satellite can then identify portions of the allocated PRB spectrum that are experiencing high interference and portions that are experiencing low interference.

In block 610, the satellite base stations are assigned PRB allocations from a set of PRBs determined to experience lower interference patterns. The assignment process is based in part on the previously monitored interference data. The assignment is also based on choosing spectrum slices or PRBs that are least affected by interference. This ensures that the satellite base stations can provide reliable service with minimal disruptions, enhancing the overall communication experience for users within the coverage area

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and sub-combinations are of utility and may be employed without reference to other features and sub-combinations and are contemplated within the scope of the claims

In the preceding detailed description, reference is made to the accompanying drawings, which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents

What is claimed is:

1. A non-transitory computer readable media having instructions stored thereon that, when executed by one or more computer processing components, cause the one or more computer processing components to perform a method for dynamic spectrum management and interference mitigation in mobile communications, the method comprising:
providing downlink coverage to a geographical area via one or more satellite base stations;
monitoring a terrestrial spectrum allocation for the geographical area via the one or more satellite base stations;
determining that the terrestrial spectrum allocation for the geographical area is being allocated from a first end of an available spectrum; and
assigning, to the one or more satellite base stations, a satellite spectrum allocation from a second end of the available spectrum.

2. The non-transitory computer readable media of claim 1, wherein the first end of the available spectrum is characterized by a first frequency range that is lower than a second frequency of the second end.

3. The non-transitory computer readable media of claim 2, wherein the first frequency range of the first end of the available spectrum is below 1 GHZ, and the second frequency range of the second end of the available spectrum is above 6 GHz.

4. The non-transitory computer readable media of claim 1, wherein the satellite spectrum allocation is selected to minimize interference with a terrestrial network based on the terrestrial spectrum allocation.

5. The non-transitory computer readable media of claim 1, wherein the first end of the available spectrum is characterized by a frequency range that is higher than a second frequency range of the second end of the available.

6. The non-transitory computer readable media of claim 1, wherein the first end of the available spectrum is characterized by a middle frequency range which is between a higher frequency range and a lower frequency range.

7. The non-transitory computer readable media of claim 1, wherein determining that the terrestrial spectrum allocation for the geographical area is being allocated from the first end of the available spectrum further comprises receiving, from a satellite constellation, an indication of the terrestrial spectrum allocation for the geographical area.

8. The non-transitory computer readable media of claim 7, wherein the receiving from the satellite constellation comprises receiving via an inter-satellite communication network.

9. The non-transitory computer readable media of claim 8, wherein the inter-satellite communication network comprises communicating between satellites within the satellite constellation by way of laser communication.

10. A system for dynamic spectrum management and interference mitigation in mobile communications, the system comprising:
one or more satellite base stations configured to monitor a terrestrial spectrum allocation for a terrestrial network within a geographical area at a first time;
data processing units within each satellite base station for:
determining that the terrestrial spectrum allocation for the geographical area is being allocated in a random pattern;
monitoring, in near real-time, an interference pattern for the terrestrial spectrum allocation; and
assigning, to the one or more satellite base stations, a satellite spectrum allocation from an available spectrum based on a determination that the satellite spectrum allocation is experiencing a lower interference pattern.

11. The system of claim 10, wherein the one or more satellite base stations comprise radio frequency detectors for monitoring uplink and downlink traffic within the terrestrial network.

12. The system of claim 10, further comprising inter-satellite laser communication channels for real-time data exchange to determine the terrestrial spectrum allocation.

13. The system of claim 10, wherein the determination that the satellite spectrum allocation is experiencing the lower interference pattern comprises monitoring interference patterns across the available spectrum.

14. The system of claim 10, wherein the satellite spectrum allocation is communicated to a second network of satellite base stations, the second network of satellite base stations configured to provide coverage to the geographical area at a second time subsequent to the first time.

15. The system of claim 14, wherein the satellite spectrum allocation is communicated to the second network of satellite base stations using inter-satellite laser communication channels.

16. A method for dynamic spectrum management and interference mitigation in mobile communications, the method comprising:
providing downlink coverage to a geographical area via one or more satellite base stations;
receiving, from a satellite constellation network, an indication that a terrestrial spectrum allocation for the geographical area is being allocated from a first end of an available spectrum; and
assigning, to the one or more satellite base stations, a satellite spectrum allocation from a second end of the available spectrum.

17. The method of claim 16, wherein the receiving the indication includes utilizing laser communication between the satellite constellation network and the one or more satellite base stations.

18. The method of claim 16, wherein the satellite constellation network determines that the terrestrial spectrum allocation is being allocated from the first end of the available spectrum based on monitoring uplink singles from one or more terrestrial user equipment (UE) to one or more terrestrial base stations.

19. The method of claim 16, wherein the first end of the available spectrum is characterized by a frequency range lower than the second end of the available spectrum.

20. The method of claim 19, wherein the lower frequency range of the first end of the available spectrum is below 1 GHZ, and the higher frequency range of the second end of the available spectrum is above 6 GHz.
